(19) United States
(12) Patent Application Publication
(10) Pub. No.: US 2012/0000811 A1
(43) Pub. Date: Jan. 5, 2012

(54) Methods for Manufacturing a Vacuum Chamber and Components Thereof, and Improved Vacuum Chambers and Components Thereof

(75) Inventors: Charles DeVentura, Venetia, PA (US); David Manko, Jefferson Hills, PA (US); David Kotsch, Yreka, CA (US)

(73) Assignee: Kurt J. Lesker Company, Clairton, PA (US)

(21) Appl. No.: 13/173,070

(22) Filed: Jun. 30, 2011

Related U.S. Application Data
(60) Provisional application No. 61/361,041, filed on Jul. 2, 2010.

(51) Int. Cl. B65D 81/20; B23K 26/00; F16L 9/00

(52) U.S. Cl. 206/524.8; 219/121.71; 138/177; 219/121.64

(57) ABSTRACT

Methods of manufacturing a vacuum chamber and methods of forming a port tube for use in connection with a vacuum chamber are provided. Vacuum chambers, bodies, containers, port tubes, and related components made in accordance with these methods are also disclosed. Further, various laser-based arrangements and equipment (or components) that can be used in connection with these methods are further provided.

### CROSS REFERENCE TO RELATED APPLICATIONS

This application claims the benefit of priority from Provisional Patent Application No. 61/361,041, filed Jul. 2, 2010, the contents of which are incorporated herein in its entirety.

### BACKGROUND OF THE INVENTION

1. Field of the Invention

The present invention relates generally to the manufacturing of vacuum chambers and other similar containers, as well as components of such a vacuum chamber, and, in particular, to methods for manufacturing a vacuum chamber and components thereof using laser cutting and/or welding techniques and processes, as well as the resulting vacuum chambers, port tubes, and other related components thereof.

2. Description of the Related Art

As is known, a vacuum chamber is an enclosed space that permits for the appropriate evacuation of air by a pump or other arrangement, thereby resulting in a vacuum. Various fabrication or experimentation activities are often performed within the chamber, and therefore require the presence of ports for viewing the internal area of the chamber or otherwise accessing this internal area. In addition, vacuum chambers are formed in a variety of desired shapes and configurations, e.g., cylindrical, spherical, square, rectangular, “D”-shaped, etc., which often leads to certain difficulties in the manufacturing process. For example, the precise placement and shape of the ports or other openings is critical to maintain the vacuum and ensure proper sealing in the arrangement. Accordingly, known manufacturing processes involve the creation of ports in the vacuum chamber wall by boring or cutting a hole through the material of the chamber body.

In one known fabrication process, these ports or openings are created in the wall of the chamber after the body has been formed into the desired shape. Such fabrication methods include creating the opening in the vacuum chamber wall using a milling machine or boring mill, where a cutting tool physically removes material (e.g., metal shavings) to produce the opening. Multiple cutting tools and/or a variety of different cutting tool types are required to produce a single opening, such that the fabrication time to produce this type of opening often takes inefficiently long periods of time (e.g., minutes or hours).

Another drawback associated with known vacuum chamber fabrication methods is the force exerted on the vacuum chamber body by the cutting tool during the creation of the openings. In particular, the milling machine or boring mill may use many different devices, e.g., saws, drills, end-mills, boring heads, broaches, and reamers, to produce the opening, all of which exert significant force on the chamber walls during processing. To counteract this machining force, current methods employ an elaborate fixturing and clamping arrangement in order to physically hold the vacuum chamber in place and reduce vibration.

Once the opening or hole is machined into the vacuum chamber wall, a corresponding round, square, or rectangular tube or conduit is inserted. This tube must be trimmed to match the inside profile of the vacuum chamber inner surface. Certain presently-known methods require a person to scribe or mark the inside profile of the inner surface of the vacuum chamber onto the tube. The tube is then removed from the vacuum chamber and taken to a cutting device, e.g., a saw, plasma torch, grinder, or the like, to profile the tube to match the vacuum chamber inner surface profile. This profiled tube is often referred to as a “scalloped” tube in the field of vacuum chamber design and manufacture. The accuracy of this tube scallop is critical to producing an effective weld joint in later steps in the fabrication process. Accordingly, and based upon the critical nature of this operation, it is performed by highly-skilled persons using the above-discussed cutting tools.

One final step in the fabrication process of a vacuum chamber includes welding flanges onto the tubes of the vacuum chamber. Current methods again require a skilled artisan to individually hand-weld (using, e.g., tungsten inert gas (TIG) techniques) the joint between the vacuum flange and the tube. This process, while not overly complex, is exceedingly time consuming and inconsistent between different artisans, even when using the identical equipment, techniques, and setup.

Overall, prior known methods for manufacturing a vacuum chamber or similar device exhibit a variety of drawbacks and deficiencies, as discussed above. Certain known methods for manufacturing a vacuum chamber are shown and described in U.S. Pat. No. 5,996,390 to Hiroshi et al., the content of which is incorporated herein in its entirety.

### SUMMARY OF THE INVENTION

Generally, the present invention provides methods of manufacturing or fabricating a vacuum chamber and related components and the resulting chamber or components thereof that address some or all of the deficiencies and drawbacks that exist in the above-discussed known methods and processes. Preferably, the present invention provides methods of manufacturing or fabricating a vacuum chamber and related components and the resulting chamber or components thereof that effectively use laser and/or new welding techniques. Preferably, the present invention provides methods of manufacturing or fabricating a vacuum chamber and related components and the resulting chamber or components thereof that increase or lead to more efficient manufacturing and fabrication. Preferably, the present invention provides methods of manufacturing or fabricating a vacuum chamber and related components and the resulting chamber or components thereof that increase or lead to more consistent manufacturing and fabrication processes.

In one preferred and non-limiting embodiment, provided is a method of manufacturing a vacuum chamber, including: (a) providing a flat portion of material; (b) forming at least one opening extending through the flat portion of material using a laser device; and (c) forming the flat portion of material having at least one opening extending therethrough into a shaped body.

In another preferred and non-limiting embodiment, provided is a method of manufacturing a vacuum chamber, including: (a) providing a shaped body; (b) mounting the shaped body in a specified position with respect to a laser device; and (c) forming at least one opening extending through the shaped body using the laser device.

In a further preferred and non-limiting embodiment, provided is a method of forming a shaped port tube for a vacuum chamber, including: (a) mounting at least one tube on a positioning arrangement; and (b) cutting, in at least one of a specified geometric shape and a specified penetration angle, at least one end of the at least one tube using a laser device.

In a still further preferred and non-limiting embodiment, provided is a method of forming a port tube for a vacuum chamber, including: (a) providing at least one tube and at least one flange member; (b) mounting the at least one tube in a specified position with respect to a laser device; and (c) welding the at least one flange member to at least one end of the at least one tube using the laser device.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of an arrangement for use in implementing a method of manufacturing a vacuum chamber according to the principles of the present invention;

FIG. 2 is a schematic view of an arrangement for use in implementing a method of manufacturing a vacuum chamber according to the principles of the present invention;

FIGS. 3(a) and (b) are views of a step in a method of manufacturing a vacuum chamber according to the principles of the present invention;

FIG. 4 is a perspective view of a step in a method of manufacturing a vacuum chamber according to the principles of the present invention;

FIG. 5 is a partial perspective view of a vacuum chamber made in accordance with a method of manufacturing a vacuum chamber according to the principles of the present invention;

FIG. 6 is a partial perspective view of a vacuum chamber made in accordance with a method of manufacturing a vacuum chamber according to the principles of the present invention;

FIG. 7 is a partial perspective view of a vacuum chamber made in accordance with a method of manufacturing a vacuum chamber according to the principles of the present invention;

FIG. 8 is a perspective view of a vacuum chamber made in accordance with a method of manufacturing a vacuum chamber according to the principles of the present invention;

FIG. 9 is a perspective view of a vacuum chamber made in accordance with a method of manufacturing a vacuum chamber according to the principles of the present invention;

FIG. 10 is a perspective view of a vacuum chamber made in accordance with a method of manufacturing a vacuum chamber according to the principles of the present invention;

FIG. 11(a)-(c) are views of a vacuum chamber made in accordance with a method of manufacturing a vacuum chamber according to the principles of the present invention;

FIG. 12 is a schematic view of an arrangement for use in implementing a method of forming a port tube for a vacuum chamber according to the principles of the present invention;

FIG. 13 is a perspective view of a step in a method of forming a port tube for a vacuum chamber according to the principles of the present invention;

FIG. 14 is a schematic view of an arrangement for use in implementing a method of forming a port tube for a vacuum chamber according to the principles of the present invention; and

FIG. 15 is a side sectional view of a step in a method of forming a port tube for a vacuum chamber according to the principles of the present invention.

### DETAILED DESCRIPTION OF THE PREFERRED EMBODIMENTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. Further, it is to be understood that the invention may assume various alternative variations and step sequences, except where expressly specified to the contrary.

The present invention is directed to methods and arrangements for manufacturing or forming vacuum chambers, containers, port tubes, and other components for use in a variety of fields and applications, as well as the vacuum chambers (and/or bodies, containers, and the like), port tubes, and related components made in accordance with these methods. In particular, one focus of the presently-invented methods and arrangements are vacuum chambers and other vessels that require precision in the manufacturing or forming process. Accordingly, while, as discussed hereinafter, the methods and arrangements are directed to vacuum chambers and its associated components, such innovative methods and arrangements can also be used in connection with other specially-manufactured vessels and containers.

As discussed above, there are a variety of drawbacks associated with known methods and arrangements for manufacturing and forming a shaped vacuum chamber and its components, such as a port tube and other attachments. In one preferred and non-limiting embodiment, and as illustrated in schematic form in FIG. 1, a method of manufacturing a vacuum chamber is provided. This method includes providing a flat portion of material M, such as a portion of stock material, metal sheet stock, or the like. For example, this metal sheet stock, may have a thickness in the range of about ⅛ inch to ¼ inch. Next, one or more openings O are formed on the flat portion of material M. In particular, this formation process is performed or implemented using a laser device L. After all of the appropriate openings O are formed or cut into the flat portion of material M, this modified flat portion of material M is formed into a shaped body B. Therefore, the openings O are provided in the shaped body B (which represents the central component of a vacuum chamber) so as to exhibit the required measurements, geometric shape, and angle of penetration (kerf), thus resulting in a precise and accurate product.

In order to effectively form the openings O, and in one preferred and non-limiting embodiment, the laser device L is a multiple axis laser device. Further, this laser device L may be controlled by a user U either directly or through some controller C, which can be integrated with or in communication with the laser device L, such that the laser device L may be programmable to perform one or more cutting actions with respect to the material M. Accordingly, the controller C includes the appropriate hardware and software (programmable instructions) in order to allow direct, manual, or automated control of the laser device L to cut or form the opening O in a specified geometric shape with a specified penetration angle.

The ability to precisely and accurately control the formation or cutting of the openings O are required when working with the flat piece of material M, such that when the material M is thereafter formed into the shaped body B, the resulting openings O exhibit the necessary geometric shape, penetration angle, dimensions, and other properties for subsequent use. Further, the shaped body B may take a variety of forms, such as a cylindrical shape, a square shape, a rectangular shape, a “D” shape, or the like. Therefore, the opening O formed in the flat piece of material M must be accurate during the formation process such that the further manipulation of the material M into the body B yields a correctly dimensioned opening O.

As discussed, the proper geometric shape and penetration angle are important in establishing a tight tolerance between the opening O and a port tube T (as discussed hereinafter) after the flat sheet of material M is formed into its final shaped body B. This method allows for the fabrication of a vacuum chamber while the chamber material M is in a convenient flat state, without the use of a milling machine or other chip-generating machine tool. This results in a substantial cost savings in the formation process and a reduction in labor costs.

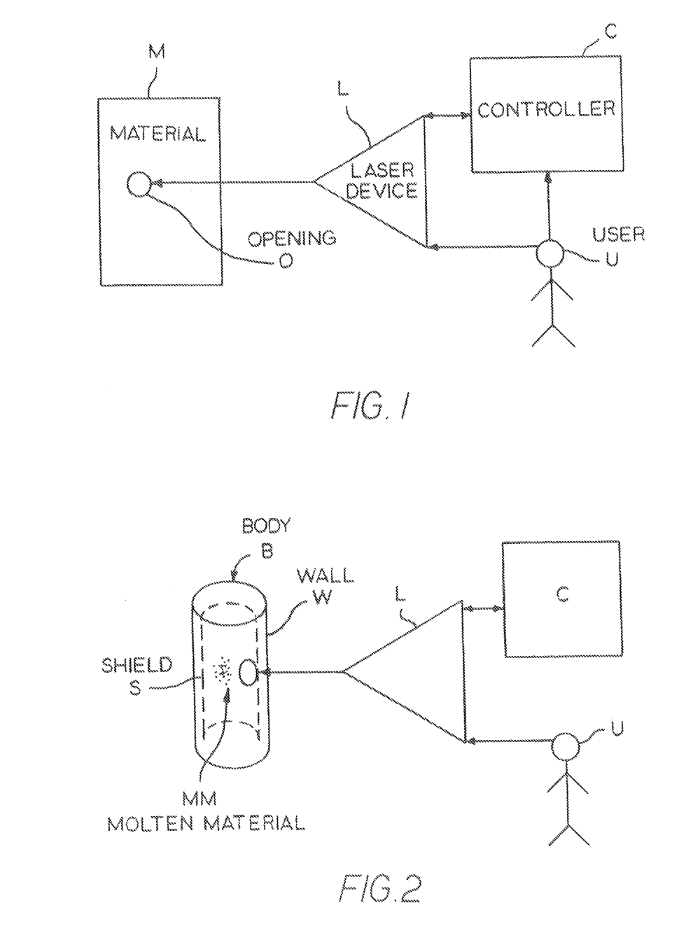

As illustrated in FIG. 2, and in another preferred and non-limiting embodiment, the laser device L can be used to form one or more openings O on or through the shaped body B (i.e., after formation of the desired geometric shape). Accordingly, the shaped body B is mounted in a specified position with respect to the laser device L, and either the laser device L is a multiple axis laser device or the mounting structure is movable in order to effectively form and cut the openings O. In addition, a laser device L with an articulating laser head can also be used to form these openings O, where the laser head can move with respect to the shaped body B.

In another embodiment, a shield S is positioned within the shaped body B during at least a portion of the formation step. This shield S is used to prevent the molten material MM from contacting or impacting the inner surface, such as the opposing inner surface, of the shaped body B.

In this embodiment, the three-dimensional chamber body B can be mounted in a fixed position on a laser table or other structure, and by using an articulating laser head, the laser device L can move around the body B to produce the appropriate openings O (or port holes). Of course, the laser table can be a controlled and movable structure for use in connection with a laser device L. In this manner, the laser device L is capable of making the final opening O in a single pass. Further, such a method is particularly useful in connection with openings O (or ports) that intersect the wall W of the body B at a right angle. Further, this method is useful in connection with openings O (or ports) that are angled in relation to a vertical axis extending through the shaped body B. Still further, this method is useful in connection with openings O (or ports) that are offset from the vertical axis extending through the shaped body B.

As discussed above, a shield S may be used and placed inside the shaped body B during the formation of the openings O in order to ensure that the molten material MM is not sprayed or splattered onto the inner surface of the chamber wall W opposite the laser beam penetration. It is preferable that the shield S not touch the inner surface of the shaped body B at any point around or near the cutting location.

Unlike prior art methods, the use of this laser-based cutting or formation method applies very little force to the part or body B during the cutting operation. This, in turn, allows for minimal fixturing for rigidity, thus resulting in a reduced setup step and the associated labor cost. By using the laser device L, the presently-invented methods are capable of producing a suitably-sized opening O approximately 20 times faster than traditional port cutting utilizing chip-style machining centers.

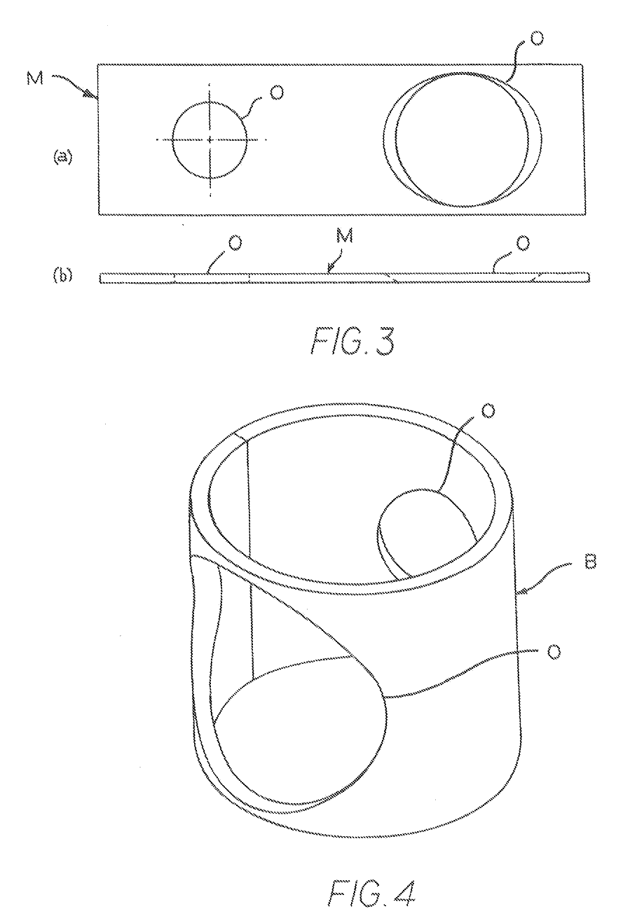

FIG. 3 illustrates openings O that are cut in the flat piece material M using the method of the present invention. As seen, these openings O may be a circular shape or (based upon the final configuration of the chamber body B) elliptical in shape. Accordingly, it can be seen that the geometric shape and penetration angle are important to ensure proper configuration of the opening O (or port) when the flat portion material M is subsequently formed into the shaped body B. This formation step is illustrated in FIG. 4.

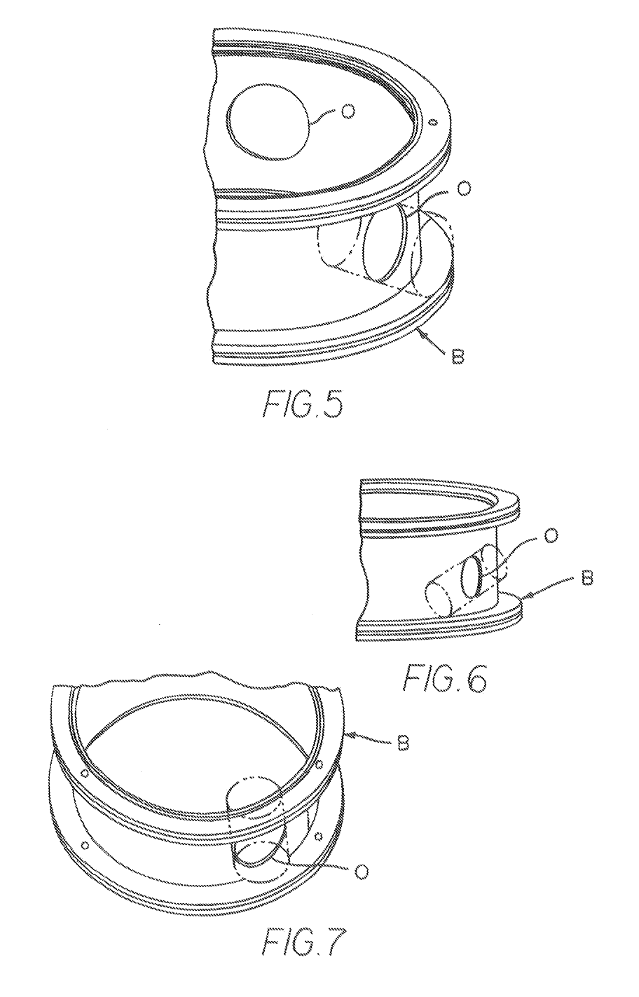

Openings O formed in a cylindrical shaped body B are illustrated in FIGS. 5-7. In particular, FIG. 5 demonstrates the formation of an opening O that intersects the chamber wall W at a right angle, i.e., an on-axis hole or opening O. FIG. 6 illustrates the formation of an opening O that is angled in relation to a vertical axis extending through the cylindrical shaped body B. Further, FIG. 7 illustrates the formation of an opening O that is offset from this vertical axis, i.e., an off-axis hole or opening O. Such openings O (or ports) can be accurately and precisely provided using the above-described methods using the laser device L.

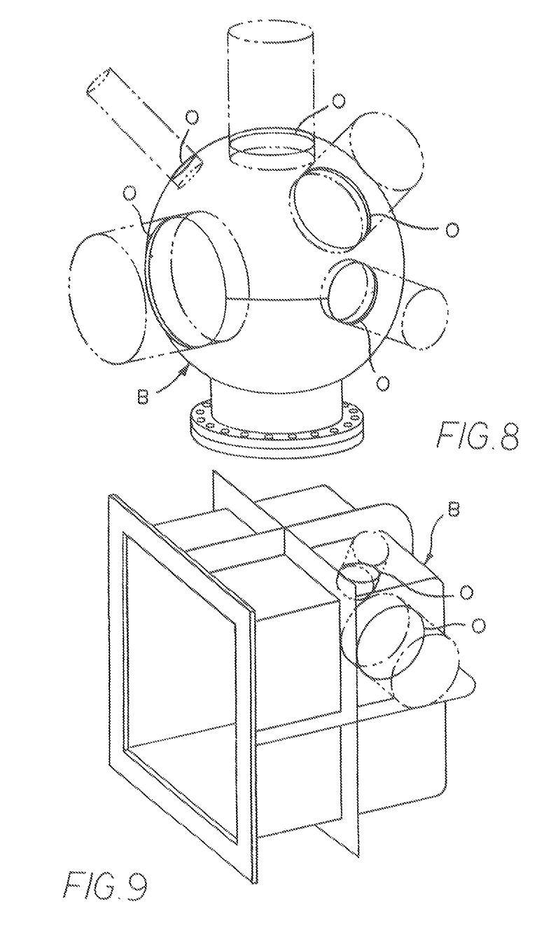

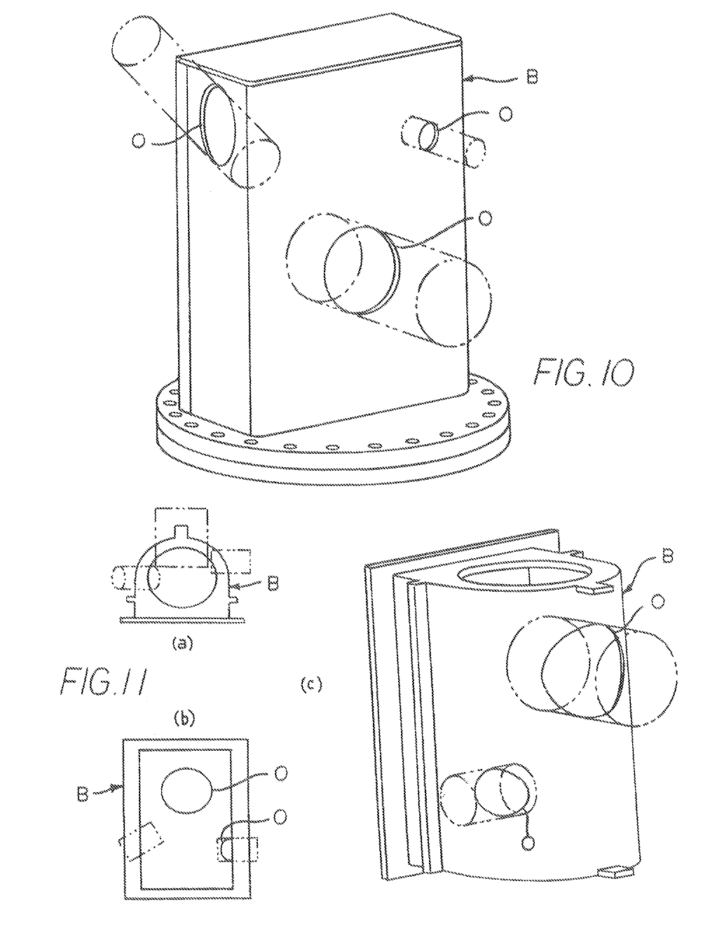

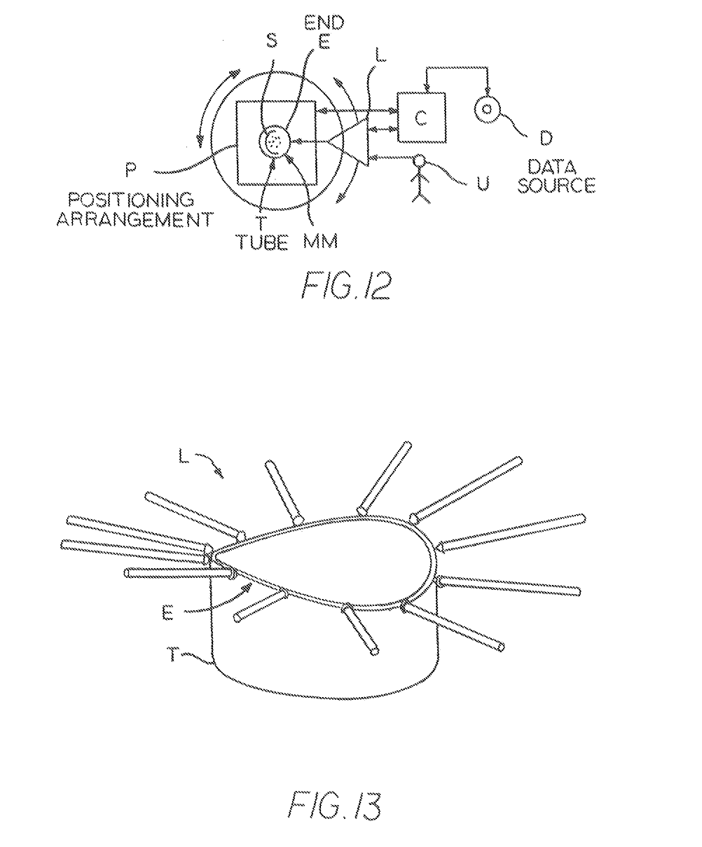

FIG. 8 illustrates a spherical-shaped body B with various openings O (or ports) formed through the wall W. FIG. 9 demonstrates the use of the presently-invented methods in connection with a square-shaped body B, again with multiple openings O formed through the wall W. FIG. 10 illustrates a rectangular-shaped body B with various styles of openings O cut or formed through the wall W. FIGS. 11(a)-(c) demonstrate the use of the presently-invented methods in connection with a D-shaped body B, again with various types of openings O (or ports) formed through the wall W of the body B.

In another preferred and non-limiting embodiment of the present invention, a shaped port tube T is formed. As discussed above, such a tube T must be accurately and precisely formed so as to sealingly engage with a corresponding opening O in the wall W of the body B. Therefore, a tube T is mounted on some positioning arrangement P. Thereafter, a specified geometric shape and penetration angle are applied, formed, or cut on an end E of the tube T. This formation or cutting must be accurate since the tubes T must be “scalloped” to match the radius of the chamber body B.

In order to provide this accurate profile (scallop, saddle, or the like), a multiple axis laser can be used in connection with a rotary positioning arrangement P. In this manner, the laser device L can cut both the proper shape on the end E of the tube T, as well as the proper penetration angle. It is further envisioned that the positioning arrangement P as well as (or alternatively) the laser device L can move with respect to the tube T.

In a further preferred and non-limiting embodiment, the laser device L and/or the positioning arrangement P is programmable or controllable, such as through the controller C, to automatically cut the end E of the tube T based upon some data source D. This data source D may be a computer file, a design file, a three-dimensional data file, a computer-aided design file, or the like, and may be used in connection with the controller C or directly with the laser device L. Further, and as discussed above in connection with the shaped body B, a shield S can be used and positioned within the tube T during the forming and cutting in order to prevent molten material MM from impacting an opposing or inner surface of the tube T.

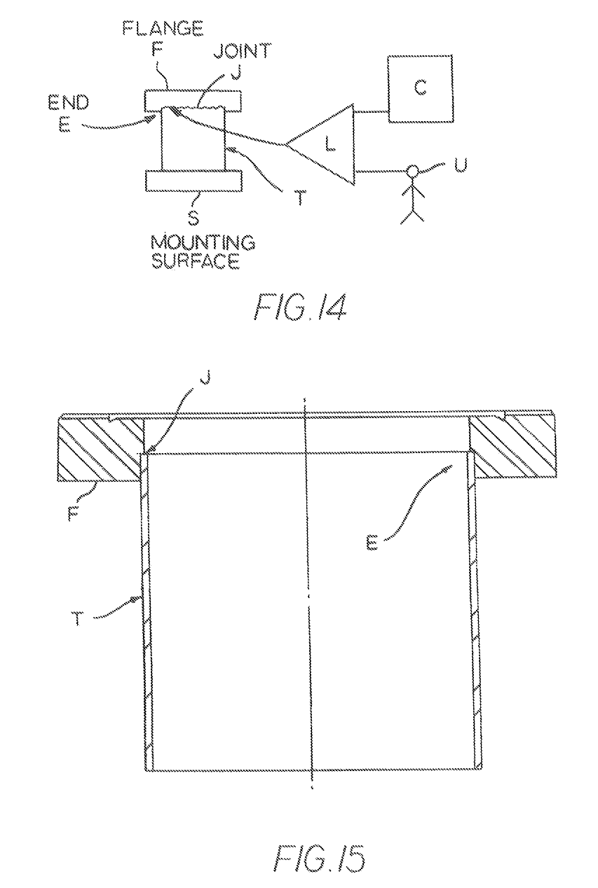

As illustrated in FIG. 13, the laser device L can be a multiple axis laser device or an articulating laser device L, such as a laser device L with a movable head (or multiple heads). Still further, and in one preferred and non-limiting embodiment, the laser device L may be permitted to move in an x-direction and a y-direction, as well as an angled pattern, while the positioning arrangement P rotates the tube T with respect to the laser device L. Any such functional positioning and movement of the tube T can be used in order to ensure precise and accurate cutting or forming of the end E of the tube T.

In a still further preferred and non-limiting embodiment of the present invention, the port tube T can be connected with a flange F using a laser device L to weld the flange F to the tube T, i.e., an end E of the tube T. Accordingly, the tube T may be mounted in some specific position with respect to the laser device L, such as through the use of a positioning arrangement P, a table, or other surface to which the tube T can be securely mounted. As seen in FIGS. 14 and 15, the laser device L can be used to weld the flange F to the tube T, such as through the use of a multiple axis laser device, an articulating laser device (or head), a programmable laser device L, or the like. As is known, this flange F is typically a Conflat or QF/KF-type flange welded to an end E opposite the end E attached to the vacuum chamber shaped body B.

By using the laser device L to weld the flange F to the tube T, the use of a person can be avoided, as this person must be skilled and individually hand-weld the joint J between the flange F and the tube T in these known methods. In addition, a mounting surface MS can be provided to which the tube T is mounted for welding in the flange F, and this mounting surface MS may hold multiple tube T/flange F combinations. Therefore, this mounting surface MS can be in the form of a laser table, and these multiple arrangements can be sequentially welded as a batch. Accordingly, in one preferred and non-limiting embodiment, the tube T/flange F is stationary and the laser device L moves around the parts applying a weld in the appropriate location. Power and weld speed settings are dependent upon the size and thickness of the tube T and flange F to be welded, and in order to produce the desired level of weld penetration.

According to this method, the laser weld produces a small heat-effected zone with respect to typical TIG welding processes used in this application. The smaller heat-effected zone, in turn, minimizes heat induced warping of the flange F. In addition, the weld rate of the conventional method of hand TIG welding of the flanges F is approximately five inches per minute. However, the presently-invented method can be effectively implemented to weld 100 inches per minute, again resulting in a significant time and cost savings. Further, through the use of a programmable laser device L (or controller C), the controlled laser device L provides consistency not only in the particular weld of one tube T/flange F set, but also across the different sets.

In this manner, the presently-invented methods and arrangement provide for the rapid, efficient, effective, and accurate production and fabrication of a vacuum chamber body, the associated openings O (or ports), as well as the tube T attached to the body B. Further, these methods and arrangements provide for a reduction in cost and labor time, as well as a reduction in the delivery cycle, since processing times are faster than conventional methods. Further, the use of the laser device L allows for reduced force or pressure on the parts with respect to traditional machine tool setup requirements. In addition, the laser welding of the flanges F to the tubes T will allow for full penetration welds, which have not been previously utilized. A full penetration weld minimizes the chances of conventional and virtual leaks, in addition to increasing the strength of the weld. Still further, reduced heat-effected zones through the use of laser welding reduce heat-induced warping of the flanges F. Further, laser welding is more consistent with respect to hand welding.

In another preferred and non-limiting embodiment, the present invention provides vacuum chambers (and/or bodies, containers, and the like), shaped port tubes, port tubes, and related components made wholly or partially using one or more of the above-described methods and manufacturing processes and methods. In addition, and in another preferred and non-limiting embodiment, the present invention provides certain laser-based arrangements and equipment (or components) that can be beneficially used in connection with the above-described methods to manufacture or produce improved vacuum chambers (and/or bodies, containers, and the like), shaped port tubes, port tubes, and related components.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of manufacturing a vacuum chamber, comprising:
(a) providing a flat portion of material;
(b) forming at least one opening extending through the flat portion of material using a laser device; and
(c) forming the flat portion of material having at least one opening extending therethrough into a shaped body.

2. The method of claim 1, wherein the laser device is a multiple axis laser device.

3. The method of claim 1, wherein the laser device is configured to be controlled by at least one user.

4. The method of claim 1, wherein the laser device is a programmable laser device configured to perform at least one automated cutting action.

5. The method of claim 1, wherein the at least one opening that is formed in the flat portion of material is substantially in the shape of an ellipse.

6. The method of claim 1, wherein the shaped body is at least one of the following: a cylindrical shape, a square shape, a rectangular shape, a “D” shape, or any combination thereof.

7. The method of claim 1, wherein the forming step (b) comprises cutting the at least one opening in a specified geometric shape with a specified penetration angle.

8. A vacuum chamber made in accordance with the method of claim 1.

9. A method of manufacturing a vacuum chamber, comprising:
(a) providing a shaped body;
(b) mounting the shaped body in a specified position with respect to a laser device; and
(c) forming at least one opening extending through the shaped body using the laser device.

10. The method of claim 9, wherein the laser device comprises an articulating laser head configured to move with respect to the shaped body.

11. The method of claim 9, wherein the at least one opening is at least one of the following: at least one port that intersects a wall of the vacuum chamber at a right angle; at least one port that is angled in relation to a vertical axis extending through the shaped body, at least one port that is offset from the vertical axis extending through the shaped body, or any combination thereof.

12. The method of claim 9, further comprising positioning a shield within the shaped body during at least a portion of the forming step (c) to prevent at least a portion of molten material from impacting at least a portion of an inner surface of the shaped body.

13. A vacuum chamber made in accordance with the method of claim 9.

14. A method of forming a shaped port tube for a vacuum chamber, comprising:
(a) mounting at least one tube on a positioning arrangement; and
(b) cutting, in at least one of a specified geometric shape and a specified penetration angle, at least one end of the at least one tube using a laser device.

15. The method of claim 14, wherein the laser device is a multiple axis laser device.

16. The method of claim 14, wherein the positioning arrangement is a rotary positioning device.

17. The method of claim 14, wherein at least one of the laser device and the positioning arrangement is programmable to automatically cut the at least one end of the at least one tube based upon at least one data source.

18. The method of claim 17, wherein the at least one data source comprises at least one of the following: a computer file, a design file, a three-dimensional data file, a computer-aided design file, or any combination thereof.

19. The method of claim of claim 14, further comprising positioning a shield within the at least one tube during at least a portion of the cutting step (b) to prevent at least a portion of molten material from impacting at least a portion of an inner surface of the at least one tube.

20. A shaped port tube for a vacuum chamber made in accordance with the method of claim 14.

21. A method of forming a port tube for a vacuum chamber, comprising:
(a) providing at least one tube and at least one flange member;
(b) mounting the at least one tube in a specified position with respect to a laser device; and
(c) welding the at least one flange member to at least one end of the at least one tube using the laser device.

22. The method of claim 21, wherein the laser device comprises an articulating laser head configured to move with respect to the at least one tube.

23. The method of claim 21, wherein the laser device is a programmable laser device configured to perform at least one automated welding action.

24. A port tube for a vacuum chamber made in accordance with the method of claim 21.
